(19) United States
(12) Patent Application Publication
(10) Pub. No.: US 2023/0080232 A1
(43) Pub. Date: Mar. 16, 2023

(54) SECONDARY BATTERY

(71) Applicant: Prime Planet Energy & Solutions, Inc., Tokyo (JP)

(72) Inventor: Mitsuhiro OKADA, Himeji-shi (JP)

(21) Appl. No.: 17/931,900

(22) Filed: Sep. 14, 2022

(30) Foreign Application Priority Data
Sep. 16, 2021 (JP) 2021-151123

(51) Int. Cl. H01M 50/533; H01M 50/543

(52) U.S. Cl. CPC H01M 50/533; H01M 50/543

(57) ABSTRACT

A technique is provided which reduces an external load, such as vibration and impact, applied on a boundary between an electrode body and an electrical collector tab. The herein disclosed secondary battery includes an electrode body, a case main body, and a cover. The cover includes an electrical collector terminal attached via an insulating material. The electrode body includes an electrical collector tab. The electrical collector tab includes an extension part that extends from the electrode body, and a branch part that extends from a tip end area of the extension part in a direction different from the extension part. The branch part includes a portion joined to the electrical collector terminal.

### CROSS REFERENCE TO RELATED APPLICATIONS

The present application claims the priority based on Japanese Patent Application No. 2021-151123 filed on Sep. 16, 2021, the entire contents of which are incorporated in the present specification by reference.

### BACKGROUND OF THE DISCLOSURE

### 1. Technical Field

The present disclosure relates to a secondary battery.

### 2. Background

Japanese Patent Application Publication No. 2018-94559 discloses a secondary battery in which a power generating element including a positive electrode tab and a negative electrode tab is accommodated inside a battery case. In the secondary battery herein disclosed, the positive electrode tab and negative electrode tab protruding from the power generating element are joined to electrical collector terminals being provided inside the battery case and having the same polarities. Via this join, the positive electrode tab and the negative electrode tab are electrically connected to electrode terminals arranged outside the battery case.

In addition, Japanese Patent Application Publication No. 2020-167010 discloses a secondary battery that includes an electrode body provided with a tab, an outer package provided with an electrode body, and a sealing plate configured to seal the outer package and including a terminal. In the secondary battery herein disclosed, an electrical collector body is attached to a sealing plate via an insulating member. Via this electrical collector body, the tab and the terminal are electrically connected.

### SUMMARY OF THE INVENTION

Anyway, the present inventor has hoped to reduce an external load, such as vibration and impact, applied to a boundary between the electrode body and the electrical collector tab when the electrical collector tab and the electrical collector terminal are joined.

According to the herein disclosed techniques, a secondary battery is provided that includes an electrode body, a case main body that has an opening for accommodating said electrode body, and a cover that is attached to said opening of said case main body. In this secondary battery, said cover includes an electrical collector terminal that is attached via an insulating material. Said electrode body includes an electrical collector tab. Said electrical collector tab includes an extension part that extends from said electrode body, and a branch part that extends from a tip end area of said extension part in a direction different from said extension part. Said branch part includes a portion that is joined to said electrical collector terminal.

The electrical collector tab includes the extension part that extends from the electrode body and includes the branch part that extends from the tip end area of the extension part in a direction different from the extension part, and the branch part is joined to the electrical collector terminal. In other words, the electrical collector tab and the electrical collector terminal are joined at a position deviated from the extending direction of the extension part. Thus, when the electrical collector tab and the electrical collector terminal are joined, it is possible to reduce an external load applied to a portion (a boundary between the electrode body and the electrical collector tab) becoming a starting point where the extension part starts extending from the electrode body. By reducing the external load applied at the join time to the portion becoming a starting point where the extension part starts extending from the electrode body, the damage risk on the electrical collector tab is reduced.

In one preferable aspect of the herein disclosed secondary battery, said branch part extends from said tip end area of said extension part in a direction approximately vertical to a direction in which said extension part extends from said electrode body. In accordance with such a configuration, the external load is hardly applied to the portion becoming the starting point for extending from the extension part, and thus, the damage risk on the electrical collector tab is reduced.

In another preferable aspect, said branch part includes a first branch part and a second branch part. Said first branch part extends from said tip end area of said extension part in a direction approximately vertical to a direction in which said extension part extends from said electrode body, and said second branch part extends in a direction opposite to a direction in which said first branch part extends. In accordance with such a configuration, the extension part at opposite sides is supported by the first branch part and the second branch part both joined to the electrical collector terminal. Thus, the external load is hardly applied to the portion becoming the starting point for extending from the extension part, and thus the damage risk on the electrical collector tab is reduced. In addition, the join area size of the electrical collector tab and the electrical collector terminal can be increased, and thus it is possible to further reduce the resistance of the secondary battery.

In another preferable aspect, said tip end area of said extension part includes a join portion that is joined to said electrical collector terminal at a tip end side. In accordance with such a configuration, the join area size is increased by making a part of the tip end area of the extension part at the tip end side be joined to the electrical collector terminal, and thus it is possible to reduce the resistance of the secondary battery. In addition, by doing this, it is possible to suppress the extension part from rising from the surface of the electrical collector terminal.

### BRIEF DESCRIPTION OF THE DRAWINGS

FIG. 1 is a partial cross-sectional view of a secondary battery 10.

FIG. 2 is a FIG. 1's II-II cross sectional view.

FIG. 3 is a plane view that shows a structure of an inner surface of a cover 14.

FIG. 4 is a schematic view that is for explaining an ultrasonic join with a negative electrode electrical collector tab 122 and a negative electrode electrical collector terminal 43.

FIG. 5 is a plane view that shows a state in which an electrode body 20 is joined to a positive electrode electrical collector terminal 33 and the negative electrode electrical collector terminal 43.

FIG. 6 is a plane view that is for explaining a state of another embodiment in which a negative electrode electrical collector tab 122 and the negative electrode electrical collector terminal 43 are joined.

FIG. 7 is a plane view that is for explaining a state where a negative electrode electrical collector tab 322 and the negative electrode electrical collector terminal 43 are joined.

### DETAILED DESCRIPTION OF THE PREFERRED EMBODIMENTS

Below, one embodiment of the herein disclosed secondary battery will be explained. The embodiment explained here is, of course, not particularly intended to restrict the present disclosure. The herein disclosed technique is not restricted to the embodiment explained here, unless specifically mentioned. Each drawing is schematically shown, and thus does not always reflect a real one. In addition, members/portions having the same effect are suitably provided with the same reference sign, and overlapping explanation would be omitted. In addition, the wording “A to B”, or the like, representing a numerical value range means “equal to or more than A and equal to or less than B”, unless specifically mentioned, and semantically covers “more than A and less than B”.

In the present specification, the term “secondary battery” means an electric storage device in general that generates a charge and discharge reaction by a charge carrier moving between a pair of electrodes (positive electrode and negative electrode) via an electrolyte. The secondary battery described above semantically covers not only so-called storage batteries, such as a lithium ion secondary battery, a nickel hydrogen battery, and a nickel cadmium battery, but also capacitors, such as an electric double layer capacitor. Below, an embodiment will be described in which the lithium ion secondary battery is set to be an object among the secondary batteries.

### Embodiment 1

<Secondary Battery 10>

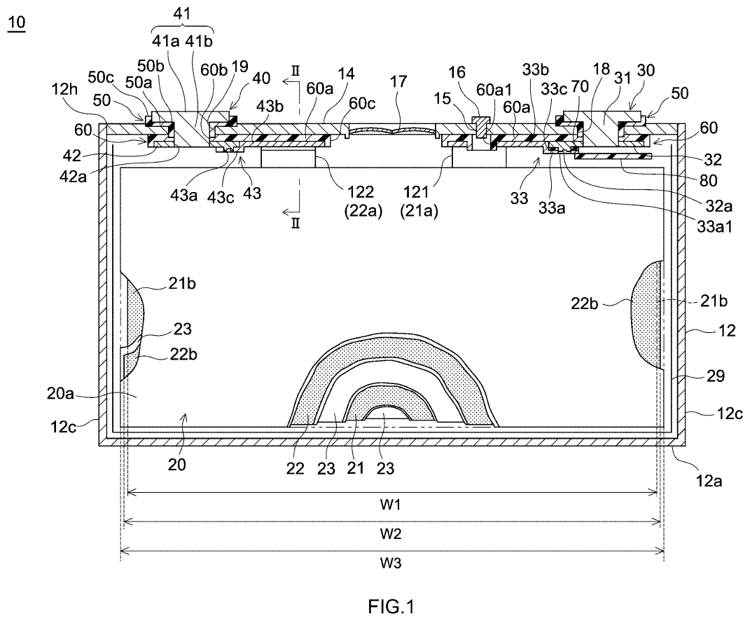

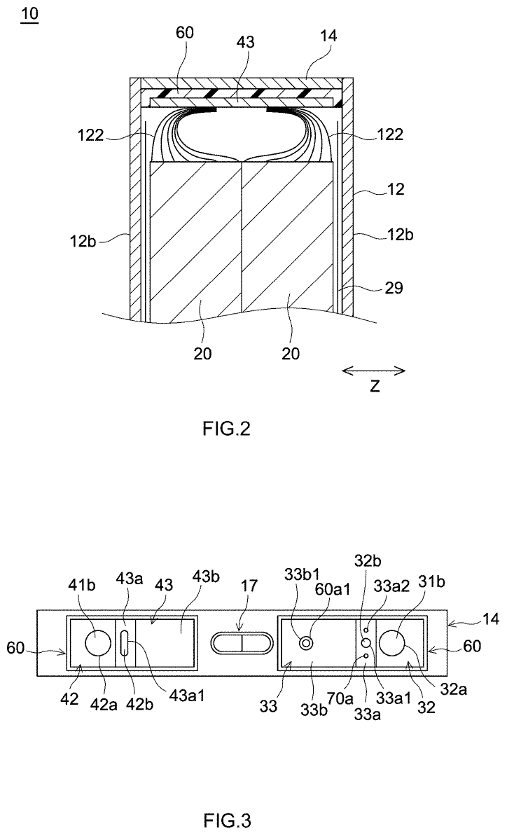

FIG. 1 is a partial cross-sectional view of a secondary battery 10. FIG. 1 shows a state in which an inside of a case main body 12 is exposed along a wide width surface at one side of the approximately rectangular parallelopiped case main body. FIG. 2 is a FIG. 1's II-II cross sectional view. FIG. 2 schematically shows a partial cross-sectional view in which a join of a negative electrode electrical collector tab 122 to a negative electrode electrical collector terminal 43 is viewed from a width narrow surface of the approximately rectangular parallelopiped case main body 12. As shown in FIGS. 1 and 2, the secondary battery 10 includes the case main body 12, a cover 14, and an electrode body 20.

<Electrode Body 20>

The electrode body 20 is a power generating element of the secondary battery 10, and includes a positive electrode, a negative electrode, and a separator that separates the positive electrode and the negative electrode. In addition, the electrode body 20 includes an electrical collector tab that is electrically connected to the outside. As shown in FIG. 2, this embodiment includes the secondary battery 10 provided with two electrode bodies 20 that are arranged adjacent to each other. These adjacent two electrode bodies 20 described above are, as shown in FIGS. 1 and 2, accommodated by the case main body 12 in a state of being covered by an insulating film 29. As shown in FIG. 1, the electrode body 20 includes a positive electrode sheet 21 as a positive electrode element, a negative electrode sheet 22 as a negative electrode element, and a separator sheet 23 as a separator. The positive electrode sheet 21 and the negative electrode sheet 22 are laminated via the separator sheet 23 so as to include a laminate structure. Here, the electrode body 20 is illustrated as a so-called laminate-type electrode body in which the positive electrode sheet 21 and negative electrode sheet 22, formed in predetermined shapes, are overlaid via the separator sheet 23.

<Positive Electrode Sheet 21>

As shown in FIG. 1, the positive electrode sheet 21 includes a positive electrode collector foil 21a formed in an approximately rectangular shape, and a positive electrode active material layer 21b formed on the positive electrode collector foil 21a. The positive electrode active material layer 21b is formed on each of both side surfaces of the positive electrode collector foil 21a. In this embodiment, a forming area of the positive electrode active material layer 21b is rectangular. The positive electrode sheet 21 includes a positive electrode electrical collector tab 121 that protrudes from one side of the forming area of the positive electrode active material layer 21b (see FIG. 5). The positive electrode electrical collector tab 121 is a part of the positive electrode collector foil 21a and is an active material layer unformed part where the positive electrode active material layer 21b is not formed on the surface. In this embodiment, a positive electrode protective layer 21p is formed at a boundary between the positive electrode active material layer 21b and the positive electrode electrical collector tab 121 (see FIG. 5). The positive electrode protective layer 21p here is formed at an end part of the positive electrode active material layer 21b in a protruding direction of the positive electrode electrical collector tab 121, and is adjacent to the positive electrode electrical collector tab 121. Incidentally, forming the positive electrode protective layer 21p is not essential.

Regarding the positive electrode collector foil 21a, for example, an aluminum foil can be used. The positive electrode active material layer 21b is a layer containing a positive electrode active substance. The positive electrode active substance is, for example, a material that can release a lithium ion at an electrically charging time and can absorb a lithium ion at an electrically discharging time, as if a lithium transition metal composite material, in a lithium ion secondary battery. Regarding the positive electrode active substance, various materials are generally proposed other than the lithium transition metal composite material, which is not particularly restricted. The positive electrode protective layer 21p is, for example, a layer containing an inorganic filler, such as an alumina.

<Negative Electrode Sheet 22>

As shown in FIG. 1, the negative electrode sheet 22 includes a negative electrode collector foil 22a formed in an approximately rectangular shape, and a negative electrode active material layer 22b formed on the negative electrode collector foil 22a. The negative electrode active material layer 22b is formed on each of both side surfaces of the negative electrode collector foil 22a. In this embodiment, a forming area of the negative electrode active material layer 22b is rectangular. The negative electrode sheet 22 includes a negative electrode electrical collector tab 122 that protrudes from one side of the forming area of the negative electrode active material layer 22b (see FIG. 5). The negative electrode electrical collector tab 122 is a part of the negative electrode collector foil 22a and is an active material layer unformed part where the negative electrode active material layer 22b is not formed on the surface.

Regarding the negative electrode collector foil 22a, for example, a copper foil can be used. The negative electrode active material layer 22b is a layer containing a negative electrode active substance. The negative electrode active substance is, for example, a material that can store a lithium ion at an electrically charging time and can release the lithium ion, stored at the electrically charging time, at an electrically discharging time, as if a natural graphite, in the lithium ion secondary battery. Regarding the negative electrode active substance, various materials are generally proposed other than the natural graphite, which is not particularly restricted.

<Separator Sheet 23>

The separator sheet 23 in this embodiment is formed in an approximately rectangular shape, and is formed bigger than the negative electrode active material layer 22b to cover the negative electrode active material layer 22b. Regarding the separator sheet 23, for example, a porous resin sheet is used which includes a required heat resistance property and through which an electrolyte can pass. Regarding further the separator sheet 23, various materials are proposed, which is not particularly restricted.

As shown in FIG. 1, a width W2 of the negative electrode active material layer 22b in a long side direction of the bottom surface 12a is larger than a width W1 of the positive electrode active material layer 21b in the same direction. A width W3 of the separator sheet 23 in a long side direction of the bottom surface 12a is larger than the width W2 of the negative electrode active material layer 22b. The positive electrode electrical collector tab 121 and the negative electrode electrical collector tab 122 each includes a necessary length to protrude from the separator sheet 23 (see FIG. 5). As shown in FIG. 1, the positive electrode sheet 21, the negative electrode sheet 22, and the separator sheet 23 are overlaid so as to make the negative electrode active material layer 22b cover the positive electrode active material layer 21b in a state of being via the separator sheet 23, and to make the positive electrode electrical collector tab 121 and the negative electrode electrical collector tab 122 protrude from the separator sheet 23. In this embodiment, on a rectangular area formed by overlaying the positive electrode sheet 21 and the negative electrode sheet 22 via the separator sheet 23, the positive electrode active material layer 21b is formed on the both surfaces of the positive electrode sheet 21, and the negative electrode active material layer 22b is formed on the both surfaces of the negative electrode sheet 22. In addition, at one end part of the above-described rectangular area, a plurality of positive electrode electrical collector tabs 121 protrude in a state of being superimposed. In addition, at the above described one end part, a plurality of negative electrode electrical collector tabs 122 protrude in a state of being superimposed.

As shown in FIGS. 1 and 2, the electrode body 20 has a flat and rectangular parallelopiped shape in which an electrode body main body part, excluding the positive electrode electrical collector tab 121 and the negative electrode electrical collector tab 122, includes a pair of wide width rectangular surfaces 20a. In this embodiment, end surfaces of the respective electrode sheets and the separator sheet 23 in the laminate direction Z configure the wide width rectangular surfaces 20a. Regarding the electrode body main body part described above, 4 side surfaces each, not the pair of wide width rectangular surfaces 20a, is a laminate surface of the positive electrode sheet 21, the negative electrode sheet 22, and the separator sheet 23.

<Case Main Body 12>

As shown in FIG. 1, the case main body 12 accommodates the electrode body 20 and includes an opening 12h for accommodating the electrode body 20. The case main body 12 has a square shape being an approximately rectangular parallelopiped whose one side surface is opened. As shown in FIGS. 1 and 2, the case main body 12 includes a bottom surface 12a being approximately rectangular, a pair of wide width surfaces 12b, and a pair of width narrow surfaces 12c. The pair of wide width surfaces 12b are respectively standing from long sides of the bottom surface 12a. The pair of width narrow surfaces 12c are respectively standing from short sides of the bottom surface 12a. The opening 12h is surrounded by long sides of the pair of wide width surfaces 12b and short sides of the pair of width narrow surfaces 12c so as to be formed. Incidentally, in this embodiment, the case main body 12 and a later-described cover 14 both are formed with aluminum or aluminum alloy whose main component is aluminum, from a perspective of light weighting and securing a necessary rigidity.

In addition, the case main body 12 might accommodate a not-shown electrolyte together with the electrode body 20. As for the electrolyte, it is possible to use a nonaqueous electrolyte in which a supporting salt is dissolved into a nonaqueous type solvent. As an example of the nonaqueous type solvent, it is possible to use a carbonate type solvent, such as ethylene carbonate, dimethyl carbonate, and ethyl methyl carbonate. As an example of the supporting salt, it is possible to use a fluorine-containing lithium salt, such as LiPF₆.

<Cover 14>

The cover 14 is attached to the opening 12h of the case main body 12. Then, a periphery part of the cover 14 is joined to a rim of the opening 12h of the case main body 12. The join as described above might be, for example, performed by continuously welding with no gap. The welding as described above can be, for example, implemented by laser welding. The case main body 12 and the cover 14 have sizes based on an accommodation number of the electrode bodies (1 or plural, the accommodation number of the embodiment shown in FIG. 2 is 2), a size of the electrode body, or the like. The cover 14 is provided with a liquid injection hole 15 and a gas exhaust valve 17. The liquid injection hole 15 is for performing liquid injection of the electrolyte after the cover 14 is joined to the case main body 12. The liquid injection hole 15 is sealed by a sealing member 16. The gas exhaust valve 17 is a thin-walled part that is configured to be broken and exhaust gas existing inside the secondary battery 10 to the outside when an internal pressure of the secondary battery 10 becomes equal to or more than a predetermined value.

In this embodiment, a positive electrode terminal 30 and a negative electrode terminal 40 are attached to the cover 14. The positive electrode terminal 30 includes a positive electrode outside terminal 31, a connecting member 32, and a positive electrode electrical collector terminal 33. The negative electrode terminal 40 includes a negative electrode outside terminal 41, a connecting member 42, and a negative electrode electrical collector terminal 43. The positive electrode outside terminal 31 and the negative electrode outside terminal 41 each is attached to the outside of the cover 14 via an outside insulating member 50. The connecting member 32 and positive electrode electrical collector terminal 33, and the connecting member 42 and negative electrode electrical collector terminal 43 each is attached to the inside of the cover 14 via an inside insulating member 60 provided at each electrode side. The connecting member 32 and positive electrode electrical collector terminal 33, and the connecting member 42 and negative electrode electrical collector terminal 43 each is arranged along an inner surface of the cover 14. The positive electrode electrical collector terminal 33 is connected to a positive electrode of the electrode body 20 (for more details, the positive electrode sheet 21) via a positive electrode electrical collector tab 121. The negative electrode electrical collector terminal 43 is connected to a negative electrode of the electrode body 20 (for more details, the negative electrode sheet 22) via a negative electrode electrical collector tab 122.

The positive electrode electrical collector tab 121 and the negative electrode electrical collector tab 122 of the electrode body 20 are, as shown in FIG. 1, respectively attached to the positive electrode electrical collector terminal 33 and the negative electrode electrical collector terminal 43 both attached to the opposite side parts of the cover 14 in the longitudinal direction. The electrode body 20 is accommodated by the case main body 12 in a state of being attached to the cover 14 via an electrical collector tab as described above. As shown in FIGS. 1 and 2, an electrode body is accommodated in the case main body 12 so as to make the wide width rectangular surface 20a be opposed to the wide width surface 12b of the case main body 12. Incidentally, connection of an electrical collector terminal and an electrical collector tab will be further described later.

Below, while a negative electrode side is treated as an example, a terminal structure of the secondary battery 10 and connection of the electrode body 20 and the cover 14 are described in details. As shown in FIG. 1, the cover 14 includes an attachment hole 19 that is for attaching a negative electrode outside terminal 41. The attachment hole 19 penetrates the cover 14 at a predetermined position of the cover 14. The negative electrode outside terminal 41 is attached to the attachment hole 19 of the cover 14 via an outside insulating member 50.

<Negative Electrode Outside Terminal 41>

Here, the negative electrode outside terminal 41 includes a head part 41a and a shaft part 41b. The head part 41a is a portion arranged outside the cover 14. The head part 41a is an approximately flat plate-shaped portion that is larger than the attachment hole 19. The shaft part 41b is a portion that is attached to the attachment hole 19 via an outside insulating member 50. The shaft part 41b protrudes downward (inward of the case main body 12 in FIG. 1) from an approximately central part of the head part 41a. A tip end of the shaft part 41b is, as shown in FIG. 1, a portion caulked by a connecting member 42 at the inside of the cover 14. A tip end of the shaft part 41b is folded and bent in a state of being inserted into the attachment hole 19 of the cover 14 and a penetration hole 42a of the connecting member 42, so as to be caulked by the connecting member 42.

<Outside Insulating Member 50>

As shown in FIG. 1, the outside insulating member 50 is a member attached to an inside surface of the attachment hole 19 of the cover 14 and attached to an outside surface of the cover 14. In this embodiment, the outside insulating member 50 includes a base part 50a, a cylinder part 50b, and a side wall 50c. The base part 50a is a portion attached to an outer surface around the attachment hole 19 of the cover 14. The base part 50a has a surface (an approximately flat surface in this embodiment) corresponding to said outer surface. The cylinder part 50b protrudes from a bottom surface of the base part 50a. The cylinder part 50b has an outer shape along an inside surface of the attachment hole to make the cylinder part be attached to the attachment hole 19 of the cover 14. An inside surface of the cylinder part 50b becomes an attached hole to which the shaft part 41b of the negative electrode outside terminal 41 is attached. The side wall 50c is standing upward from a circumferential edge of the base part 50a. The head part 41a of the negative electrode outside terminal 41 is attached to a portion surrounded by the side wall 50c of the outside insulating member 50.

The outside insulating member 50 is arranged between the cover 14 and the negative electrode outside terminal 41 so as to secure the insulation between them. In addition, the outside insulating member 50 is to secure the airtightness of the attachment hole 19 of the cover 14. From a perspective as described above, it is preferable to use a material outstanding at the chemical resistant property or the weather resistant property. In this embodiment, PFA is used for the outside insulating member 50. PFA is a copolymer (Tetrafluoroethylene-Perfluoroalkylvinylether Copolymer) with tetrafluoroethylene and perfluoroalkoxyethylene. Incidentally, the material used for the outside insulating member 50 is not restricted to PFA.

<Inside Insulating Member 60>

The inside insulating member 60 is a member attached to the inside of the cover 14 around the attachment hole 19 of the cover 14. The inside insulating member 60 includes a flat part 60a, a hole 60b, and a side wall 60c. The flat part 60a is a portion arranged along the inner surface of the cover 14. In this embodiment, the flat part 60a is a portion formed in an approximately flat plate shape. The flat part 60a has a size making the flat part not protrude from the cover 14 so as to be arranged along the inner surface of the cover 14 and be accommodated in the case main body 12. The hole 60b is a hole provided in correspondence with the attachment hole 19. In this embodiment, the hole 60b is provided at an approximately central part of the flat part 60a. The side wall 60c is standing downward from a periphery part of the flat part 60a. It is preferable that the flat part 60a has a necessary chemical resistant property because the inside insulating member 60, into which the connecting member 42 and the negative electrode electrical collector terminal 43 are accommodated, is arranged inside the case main body 12. In this embodiment, PPS is used for the inside insulating member 60. PPS is a polyphenylene sulfide resin. Incidentally, the material used for the inside insulating member 60 is not restricted to PPS.

<Connecting Member 42>

FIG. 3 is a plane view that shows a structure of the inner surface of the cover 14. As shown in FIGS. 1 and 3, the connecting member 42 is formed in an approximately flat plate shape, and includes a penetration hole 42a and a projection 42b. The connecting member 42 is a member attached to the flat part 60a of the inside insulating member 60, and connects the negative electrode outside terminal 41 and the negative electrode electrical collector terminal 43. Into the penetration hole 42a, the shaft part 41b of the negative electrode outside terminal 41 is inserted. At a periphery of the penetration hole 42a, the shaft part 41b is caulked. The projection 42b is a portion that is fit into a penetration hole 43a1 provided on a first plate part 43a of the negative electrode electrical collector terminal 43. A shape of the projection 42b is a shape capable of being fit into the penetration hole 43a1. In this embodiment, a flat surface shape of the projection 42b viewed from the inner surface side of the cover 14 is an oval shape. The connecting member 42 is, for example, formed with copper or copper alloy.

<Negative Electrode Electrical Collector Terminal 43>

As shown in FIGS. 1 to 3, the negative electrode electrical collector terminal 43 is attached to the cover 14 via an insulating material (for example, the flat part 60a of the inside insulating member 60). The negative electrode electrical collector terminal 43 includes a first plate part 43a, a second plate part 43b, and a step part 43c. The first plate part 43a is a portion arranged along a surface of the connecting member 42. In this embodiment, the first plate part 43a is a portion formed in an approximately flat plate shape. The first plate part 43a includes the penetration hole 43a1. Into the penetration hole 43a1, the projection 42b of the connecting member 42 is fit. The penetration hole 43a1 is formed in a shape capable of making the projection 42b fit into the penetration hole. The second plate part 43b is a portion arranged at the flat part 60a of the inside insulating member 60. In this embodiment, the second plate part 43b is a portion formed in an approximately flat plate shape. To the second plate part 43b, the negative electrode electrical collector tab 122 is joined. The step part 43c is a portion that is standing from one end part of the first plate part 43a toward one end part of the second plate part 43b and that couples both plate parts. In this embodiment, the step part 43c is arranged along a side wall of the connecting member 42. The negative electrode electrical collector terminal 43 is formed with, for example, copper or copper alloy.

As shown in FIGS. 1 to 3, in this embodiment, the negative electrode electrical collector tab 122 protruding from the electrode body 20 is joined to the second plate part 43b of the negative electrode electrical collector terminal 43.

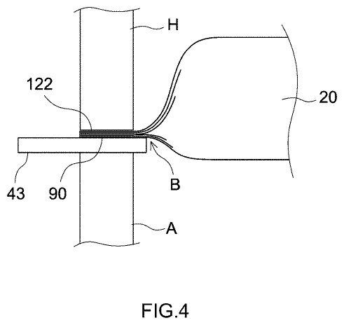

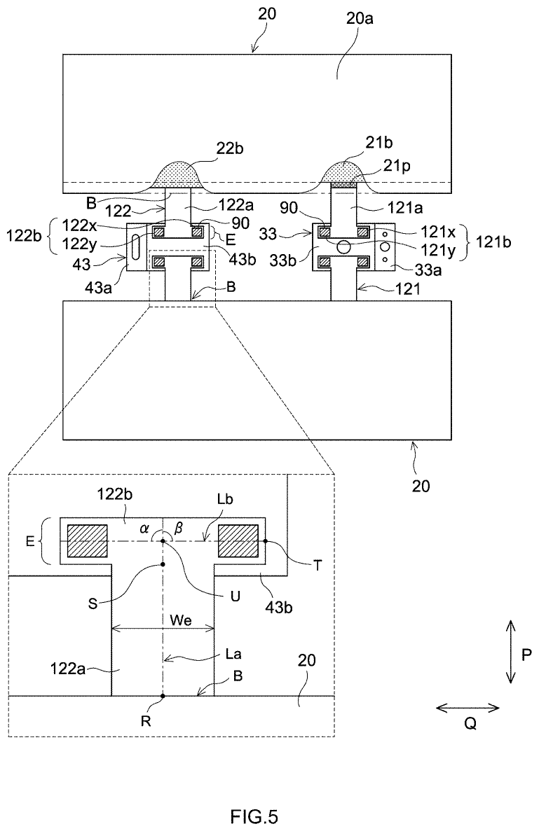

Anyway, as a joining means for joining an electrical collector tab and an electrical collector terminal, it is possible to use, for example, an ultrasonic join. FIG. 4 is a schematic view that is for explaining the ultrasonic join with the negative electrode electrical collector tab 122 and the negative electrode electrical collector terminal 43. As shown in FIG. 4, for the ultrasonic join with the negative electrode electrical collector tab 122 and the negative electrode electrical collector terminal 43, a plurality of negative electrode electrical collector tabs 122 protruding from one end part of the electrode body 20 and being laminated and the negative electrode electrical collector terminal 43 are superimposed. Next, a join planned portion 90 in these superimposed areas is sandwiched by a horn H and an anvil A of an ultrasonic join apparatus. In this embodiment, the horn H is abutted on the negative electrode electrical collector tab 122 and the anvil A is abutted on the negative electrode electrical collector terminal 43. Next, the horn H is vibrated while both members are pressurized, so as to make both members be joined.

In the ultrasonic join described above, an external load, such as vibration of the horn H, is applied to an base end B of the negative electrode electrical collector tab 122. The base end B will be described later. The present inventor considers to reduce the external load applied on a base end of an electrical collector tab at the time of join (e.g., ultrasonic join) of the electrical collector tab and the electrical collector terminal. The present inventor considered that, by doing this, it is possible to reduce a risk of said join inducing a damage on the electrical collector tab, and thus examined about a shape of the electrical collector tab and about a formed portion of the join part with the electrical collector tab and the electrical collector terminal.

FIG. 5 is a plane view that shows a state in which the electrode body 20 is joined to the positive electrode electrical collector terminal 33 and the negative electrode electrical collector terminal 43. As shown in FIG. 5, the positive electrode electrical collector terminal 33 and the negative electrode electrical collector terminal 43 are spaced away from each other and are arranged with a join surface facing upward, the join surface to which an electrical collector tab is joined. In this embodiment, after attached to the cover 14, the positive electrode electrical collector terminal 33 and the negative electrode electrical collector terminal 43 are arranged to position at a side of the gas exhaust valve 17 in which the second plate part 33b and the second plate part 43b are provided on the cover 14. Two electrode bodies 20 are arranged symmetrically with the positive electrode electrical collector tabs 121 and the negative electrode electrical collector tabs 122 that are made to face the positive electrode electrical collector terminal 33 and the negative electrode electrical collector terminal 43. Then, the positive electrode electrical collector tabs 121 and the negative electrode electrical collector tabs 122 are overlaid on the positive electrode electrical collector terminal 33 and the negative electrode electrical collector terminal 43, and then joined.

Below, here, the join of the negative electrode electrical collector tab 122 and the negative electrode electrical collector terminal 43 will be explained. In this embodiment, as shown in FIG. 5, the tip ends of the negative electrode electrical collector tabs 122 respectively extending from two electrode bodies 20 arranged symmetrically with respect to the negative electrode electrical collector terminal 43 are arranged on the above described join surface of the second plate part 43b to make the tip ends be opposed to each other. As described later in details, at least a part of the negative electrode electrical collector tab 122 is joined to the second plate part 43b so as to form a join part 90 at a join planned portion 90 (see FIG. 4). Then, after two negative electrode electrical collector tabs 122 are joined to the negative electrode electrical collector terminal 43, the negative electrode electrical collector terminal 43 in a state of having the joined negative electrode electrical collector tabs 122 is attached to the cover 14. After the negative electrode electrical collector terminal 43 is attached to the cover 14, wide width surfaces of the electrode bodies 20 are overlaid and then accommodated into the case main body 12 (see FIG. 2).

<Negative Electrode Electrical Collector Tab 122>

As shown in FIG. 5, the negative electrode electrical collector tab 122 includes an extension part 122a that extends from the electrode body 20, and a branch part 122b that extends from a tip end area E of the extension part 122a in a direction different from the extension part 122a, and the branch part 122b includes a portion (join part 90) that is joined to the negative electrode electrical collector terminal 43. In this embodiment, as shown in FIG. 5, the extension part 122a and the branch part 122b each is formed in a strip-like shape. In FIG. 5, the extension part 122a extends from the electrode body 20. In this figure, a direction in which the extension part 122a extends from the electrode body 20 is represented by an arrow P, and the direction might be below referred to as “first extending direction P”, too. The first extending direction P can be, for example, defined by a line La that connects a center R of the base end B of the extension part 122a in a width direction and a center S of the tip end area E of the extension part 122a at a base end B side in the width direction. Here, the base end B of the extension part 122a is a boundary between the negative electrode electrical collector terminal 43 and an outer edge of the electrode body 20. An outer edge of the electrode body 20 is, for example, a circumferential edge of the wide width rectangular surface 20a of the electrode body 20. The tip end area E is, for example, an area of the extension part 122a in which the branch part 122b is provided, and a base end B side of the tip end area E of the extension part 122a is a base end B side of the area of the extension part 122a in which the branch part 122b is provided.

Additionally, in FIG. 5, a direction in which the branch part 122b extends is represented by an arrow Q, and the direction might be below referred to as “second extending direction Q”, too. The second extending direction Q can be, for example, defined by a line Lb that connects a width direction center T of the branch part 122b (a center T of the branch part 122b in the first extending direction P) and a center U of the tip end area E of the extension part 122a in the first extending direction P. Then, a phrase “the branch part 122b extends from the tip end area E of the extension part 122a in a direction different from a direction in which the extension part 122a extends from the electrode body 20” means that, for example, when angles defined by the line La along the first extending direction P and the line Lb along the second extending direction are treated as α and β (it should be noted that, α≥β and α+β=180°), β is more than 10°.

˜Extension Part 122a˜

In this embodiment, as shown in FIG. 5, the extension part 122a is a portion extending from the electrode body 20 toward the second plate part 43b of the negative electrode electrical collector terminal 43. In this embodiment, the extension part 122a has a width We which is fixed from the base end B to the tip end area E of the negative electrode electrical collector tab 122. On the tip end area E, the branch part 122b extending in the second extending direction is provided. As shown in FIGS. 2 and 5, the extension part 122a is accommodated into the case main body 12 in a state of being bent, so as to make the branch part 122b be arranged along the negative electrode electrical collector terminal 43 attached to the cover 14.

˜Branch Part 122b˜

In this embodiment, while shown in FIG. 5, a first branch part 122x and a second branch part 122y are included as the branch part 122b, each of which extends from the tip end area of the extension part 122a in a direction different from the extension part 122a. The first branch part 122x and the second branch part 122y each extends in a direction approximately vertical (a long side direction of the cover 14 in FIGS. 2 and 5) to the direction (the first extending direction P in this embodiment) in which the extension part 122a extends from the electrode body 20. The wording “approximately vertical” in this embodiment means that the line La along the first extending direction P and the line Lb along the second extending direction cross in an approximately perpendicular manner, and means that the angles α and β defined by the line La and the line Lb both are 90°±10°. In addition, the second branch part 122y is a portion extending in a direction opposite to the direction in which the first branch part 122x extends from the tip end area of the extension part 122a. Then, the first branch part 122x and the second branch part 122y are joined to the negative electrode electrical collector terminal 43 (forming the join part 90).

In the secondary battery 10, the negative electrode electrical collector tab 122 includes the extension part 122a that extends from the electrode body 20, and includes the branch part 122b that extends from the tip end area E of the extension part 122a in a direction different from the extension part 122a, and the branch part 122b is joined to the negative electrode electrical collector terminal 43. In other words, at a deviated position in the extending direction (the first extending direction P in FIG. 5) of the extension part 122a, the negative electrode electrical collector tab 122 and the negative electrode electrical collector terminal 43 are joined. Thus, for example, when the negative electrode electrical collector tab 122 and the negative electrode electrical collector terminal 43 are joined by ultrasonic join, it is possible to reduce the external load applied to a portion (the base end B in FIGS. 4 and 5) that becomes a starting point at which the extension part 122a starts extending from the electrode body 20. By reducing the external load at the join time applied to the portion (the base end B) that becomes the starting point at which the extension part 122a starts extending from the electrode body 20, it is possible to reduce the damage risk on the negative electrode electrical collector tab 122.

In addition, as described above, by providing the join part 90 at the position deviated from the extension part 122a, it is possible, even after joining the negative electrode electrical collector tab 122 and the negative electrode electrical collector terminal 43, to reduce the external load (e.g., vibration, impact, or the like, applied at the time of manufacturing the secondary battery or at the time of using the secondary battery) applied on the portion (base end B) that becomes the starting point at which the extension part 122a starts extending from the electrode body 20, so as to reduce the damage risk on the negative electrode electrical collector tab 122.

The first branch part 122x and the second branch part 122y each extends from the tip end area E of the extension part 122a in an approximately vertical direction with respect to the direction in which the extension part 122a extends from the electrode body 20. Thus, the external load is hardly applied to the portion that becomes the starting point at which the extension part 122a starts extending, and therefore the negative electrode electrical collector tab 122 is hardly damaged.

In this embodiment, as shown in FIG. 5, the branch part 122b includes the first branch part 122x and the second branch part 122y. The first branch part 122x extends from the tip end area E of the extension part 122a in an approximately vertical direction with respect to the direction in which the extension part 122a extends from the electrode body 20, and the second branch part 122y extends in a direction opposite to the direction in which the first branch part 122x extends. In that case, the extension part 122a is supported at opposite sides respectively by the first branch part 122x and the second branch part 122y joined to the negative electrode electrical collector terminal 43. Thus, the external load is hardly applied to the portion that becomes the starting point at which the extension starts from the extension part 122a, and therefore the electrical collector tab is hardly damaged. In addition, it is possible to increase a join area size with the negative electrode electrical collector tab 122 and the negative electrode electrical collector terminal 43, and thus it is possible to decrease a resistance of the secondary battery 10.

<Join Part 90>

Regarding this embodiment, as shown in FIG. 5, in the direction where the branch part 122b extends from the extension part 122a (the second extending direction Q of this embodiment), the first branch part 122x and the second branch part 122y are joined to the negative electrode electrical collector terminal 43 and thus the join part 90 is formed at that portion. By joining the first branch part 122x and the second branch part 122y to the negative electrode electrical collector terminal 43, it is possible to join the negative electrode electrical collector tab 122 and the negative electrode electrical collector terminal 43 at the position being deviated from the direction (the first extending direction P), in which the extension part 122a extends, and being further away from the base end B of the negative electrode electrical collector tab 122. By doing this, it is possible to better implement the above described effect of reducing the external load and the above described effect of reducing the damage risk on the electrical collector tab.

Additionally, in this embodiment, not only the first branch part 122x is provided with the join part 90, but also the second branch part 122y is provided with the join part, and thus the point, at which the join part is formed, is increased. By doing this, the join area size with the negative electrode electrical collector tab 122 and the negative electrode electrical collector terminal 43 is increased, and the resistance of the secondary battery 10 is decreased. Incidentally, it is enough regarding the branch part 122b that at least a part of the branch part is joined to the negative electrode electrical collector terminal 43. The branch part 122b might include a portion not joined to the negative electrode electrical collector terminal 43. Although not particularly restricting, it is preferable that the area size of the join part 90 is approximately equal to or more than 30% of the area size of the single branch part 122b. Incidentally, although a flat surface shape of the negative electrode electrical collector tab 122 in this embodiment is slightly complicated, it is possible for manufacturing it to use a punching process on the negative electrode collector foil, and thus it is assumed that the difficulty for manufacturing the negative electrode electrical collector tab 122 is not so large.

The shape of the join part is not particularly restricted, if the shape can implement the effect of the herein disclosed technique. The shape of the join part 90 shown in FIG. 5 is an approximately rectangular shape, but it might be a circular shape, an oval shape, or the other shape. By suitably changing a setting of the ultrasonic join apparatus (e.g., a shape of a work object surface for the horn or the anvil), it is possible to implement a desired shape.

In the above descriptions, a terminal vicinity structure of the secondary battery 10, and a join with the electrical collector tab and the electrical collector terminal were explained with using the negative electrode side as an example. Regarding the terminal vicinity structure of the secondary battery 10, as shown in FIG. 1, a fuse member 70 is arranged between the connecting member 32 and the first plate part 33a of the positive electrode electrical collector terminal 33 at the positive electrode side. A terminal protective member 80 formed in a flat plate shape is arranged between the positive electrode outside terminal 31 and the electrode body 20. As shown in FIGS. 1 and 3, a flat part 60a of an inside insulating member 60 arranged at the positive electrode side is provided with a cylindrical opening 60a1 protruding the inward of the case main body 12. The cylindrical opening 60a1 is arranged just below the liquid injection hole 15. A first plate part 33a of a positive electrode electrical collector terminal 33 is provided with a penetration hole 33a1 to which a projection 32a of the connecting member 32 is attached, and provided with a penetration hole 33a2 to which a projection 70a provided on the fuse member 70 is attached. A second plate part 33b of the positive electrode electrical collector terminal 33 is provided with a penetration hole 33b1 to which the cylindrical opening 60a1 is attached. Any of the positive electrode outside terminal 31, the connecting member 32, and the positive electrode electrical collector terminal 33 are formed with aluminum or aluminum alloy. Incidentally, in FIG. 1, a reference sign 18 represents an attachment hole at the positive electrode side, and a reference sign 33c represents a step part of the positive electrode electrical collector terminal 33. In FIG. 3, a reference sign 31b represents a shaft part of the positive electrode outside terminal 31, and a reference sign 32b represents a projection of the connecting member 32. Configurations other than them are basically similar to configurations at the negative electrode side, and thus explanations for the similar configurations are omitted here. In addition, explanations for configurations not particularly described in the present specification, among the configurations of the fuse member and the terminal protective member and configurations different from the negative electrode side, are omitted, since the explanation-omitted configurations do not characterize the herein disclosed techniques.

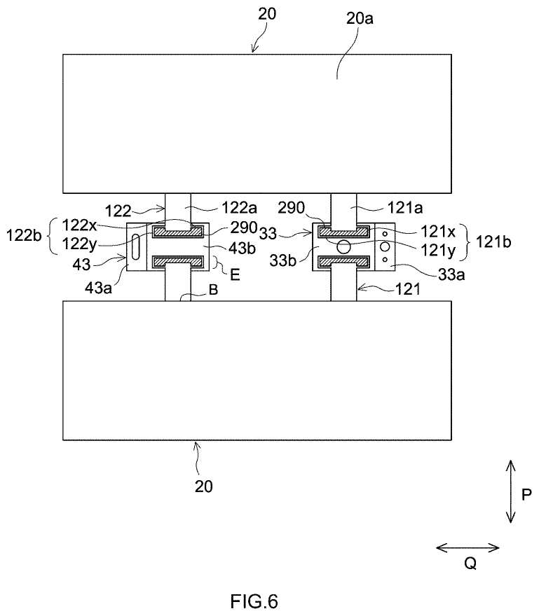

A join with the electrical collector tab and the electrical collector terminal at the positive electrode side is also similar to the join at the negative electrode side, and thus explains for it are omitted here. In FIGS. 5 and 6, a reference sign 121 represents a positive electrode electrical collector tab, a reference sign 121a represents an extension part of the positive electrode electrical collector tab 121, a reference sign 121b represents a branch part of the positive electrode electrical collector tab 121, a reference sign 121x represents a first branch part, and a reference sign 121y represents a second branch part. Incidentally, it is enough that the secondary battery 10 includes at least one among the above described join forms with the electrical collector tab and the electrical collector terminal. From a perspective of better implementing the effects of the herein disclosed techniques, it is preferable that the secondary battery 10 includes the above described join forms with the electrical collector tab and the electrical collector terminal at both of the positive electrode and the negative electrode.

In the above descriptions, one embodiment for the herein disclosed techniques were explained. Incidentally, the above described Embodiment 1 is for showing an example of the secondary battery in which the herein disclosed techniques are applied, but is not intended to restrict the herein disclosed techniques. Below, another embodiment for the herein disclosed techniques will be described. Incidentally, regarding the above described explanation, configurations other than particularly stated configurations can be approximately similar configurations to the secondary battery 10 in accordance with the above described Embodiment 1.

### Embodiment 2

In the above described Embodiment 1, the branch part 122b is joined to the negative electrode electrical collector terminal 43, but the extension part 122a is not joined to the negative electrode electrical collector terminal 43. However, this does not restrict the present disclosure. FIG. 6 is a plane view that is for explaining a state of another embodiment in which the negative electrode electrical collector tab 122 and the negative electrode electrical collector terminal 43 are joined. As shown in FIG. 6, the tip end area E of the extension part 122a includes a join portion at a tip end side that is joined to the negative electrode electrical collector terminal 43. In this embodiment, a join part 290 is formed in which the first branch part 122x and second branch part 122y, and a part at the tip end side of the tip end area E of the extension part 122a are joined to the negative electrode electrical collector terminal 43. On the other hand, a part of the extension part 122a at the base end B side of the tip end area E is not joined to the negative electrode electrical collector terminal 43. By joining a part of the extension part 122a at the tip end side of the tip end area E, in addition to the branch part 122b, onto the negative electrode electrical collector terminal 43, the join area size is increased, and thus it is possible to reduce the resistance of the secondary battery 10. In addition, by doing this, it is possible to suppress the extension part 122a from rising from the surface of the negative electrode electrical collector terminal 43. Furthermore, by making a part of the extension part 122a at the base end side B of the tip end area E be not joined to the negative electrode electrical collector terminal 43, it is possible to reduce the damage risk on the negative electrode electrical collector tab 122 when an external load is applied, because this portion has a degree of freedom for deformation. Incidentally, it is preferable that, when a length of the tip end area E of the extension part 122a in the first extending direction P is treated as 1, a portion whose length from the tip end side of the tip end area E is ¼ to ½ is joined to the negative electrode electrical collector terminal 43.

### Embodiment 3

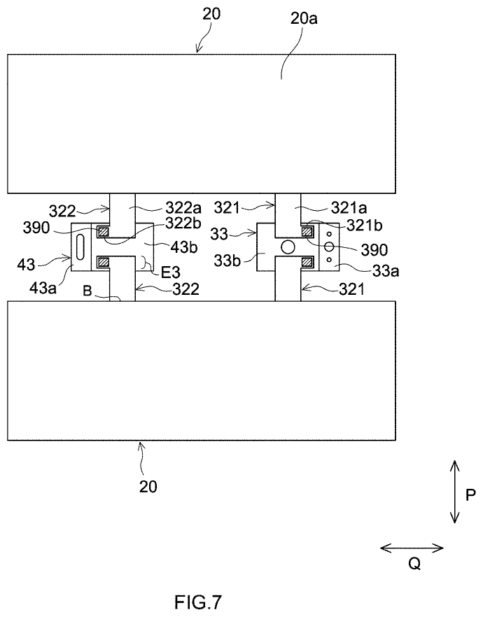

Additionally, in the above described Embodiment 1, the branch part 122b of the negative electrode electrical collector tab 122 consisted of the first branch part 122x and the second branch part 122y. However, this does not restrict the present disclosure. FIG. 7 is a plane view that is for explaining a state where the negative electrode electrical collector tab 322 and the negative electrode electrical collector terminal 43 are joined. As shown in FIG. 7, the negative electrode electrical collector tab 322 includes an extension part 322a and a branch part 322b. Regarding the negative electrode electrical collector tab 322 in this embodiment, the branch part 322b is provided only at one side of a tip end area E3 of the extension part 322a in the second extending direction Q. The extension part 322a in this embodiment is configured similarly to the extension part 122a of the negative electrode electrical collector tab 122 in the above described Embodiment 1. The branch part 322b in this embodiment is configured similarly to the first branch part 122x of the negative electrode electrical collector tab 122 in the above described Embodiment 1. Thus, about the extension part 322a and the branch part 322b of the negative electrode electrical collector tab 322, detailed explanations are omitted here. As shown in FIG. 7, in the second extending direction Q, a tip end of the branch part 322b is joined to the negative electrode electrical collector terminal 43 (forming the join part 390). Even in this embodiment, it is possible to implement the above described effect of reducing the external load and the above described effect of reducing the damage risk on the negative electrode electrical collector tab 322. In addition, the shape negative electrode electrical collector tab 322 is preferable when the area size for arranging the negative electrode electrical collector tab 122 on the negative electrode electrical collector terminal 43 is wanted to be smaller while the above described effect is implemented. Incidentally, the portion at which the branch part 322b is formed is not restricted to the above described configuration. The branch part 322b might be formed at a side of the gas exhaust valve 17 provided on the cover 14. In addition, a reference sign 321 in FIG. 7 represents a positive electrode electrical collector tab, a reference sign 321a represents an extension part of the positive electrode electrical collector tab 321, and a reference sign 321b represents a branch part of the positive electrode electrical collector tab 321.

### Another Embodiment

Additionally, in the above described Embodiment 1, any of the first branch part 122x and the second branch part 122y extends from the extension part 122a in an approximately vertical direction. However, this does not restrict the present disclosure. Although a particular illustration is omitted, the angle defined by the first branch part 122x or second branch part 122y and the extension part 122a might be set, for example, within a range more than 100° but not more than 150° (for example, 110° to 130°). Even in that case, it is possible to implement the effect of the herein disclosed techniques.

Alternatively, the branch part 122b might include a third branch part, in addition to the first branch part 122x and the second branch part 122y of the above described Embodiment 1. Although a detailed illustration is omitted, the third branch part might be a portion extending along the direction in which the extension part 122a of the above described Embodiment 1 extends (see FIG. 5). In the direction where the third branch part extends, the third branch part is joined to the negative electrode electrical collector terminal 43. Even in this embodiment, it is possible to implement the effect of reducing the external load and the effect of reducing the damage risk on the electrical collector tab.

Furthermore, although the electrode body 20 included by the secondary battery 10 in accordance with the above described Embodiment 1 was a laminate-type electrode body, a wound electrode body might be used. In addition, the joining means for the electrical collector tab and the electrical collector terminal is not restricted to the ultrasonic join, and the joining means might be a conventionally known joining means, such as a laser welding or a resistance welding.

What is claimed is:

1. A secondary battery, comprising:
an electrode body;
a case main body that has an opening for accommodating the electrode body; and
a cover that is attached to the opening of the case main body,
wherein the cover comprises an electrical collector terminal that is attached via an insulating material,
the electrode body comprises an electrical collector tab,
the electrical collector tab comprises:
an extension part that extends from the electrode body; and
a branch part that extends from a tip end area of the extension part in a direction different from the extension part, and
the branch part comprises a portion that is joined to the electrical collector terminal.

2. The secondary battery according to claim 1,
wherein the branch part extends from the tip end area of the extension part in a direction approximately vertical to a direction in which the extension part extends from the electrode body.

3. The secondary battery according to claim 1,
wherein the branch part comprises a first branch part and a second branch Part,
the first branch part extends from the tip end area of the extension part in a direction approximately vertical to a direction in which the extension part extends from the electrode body, and
the second branch part extends in a direction opposite to a direction in which the first branch part extends.

4. The secondary battery according to claim 1,
wherein the tip end area of the extension part comprises a join portion that is joined to the electrical collector terminal at a tip end side.
